(19) United States
(12) Patent Application Publication
(10) Pub. No.: US 2020/0368681 A1
(43) Pub. Date: Nov. 26, 2020

(54) ARCHITECTURED MATERIALS AS ADDITIVES TO REDUCE OR INHIBIT SOLID FORMATION AND SCALE DEPOSITION AND IMPROVE HYDROGEN SULFIDE SCAVENGING

(71) Applicant: Baker Hughes, a GE company, LLC, Houston, TX (US)

(72) Inventors: Mary Jane Legaspi Felipe, Sugar Land, TX (US); Ramakrishna Ponnapati, Houston, TX (US)

(73) Assignee: Baker Hughes, a GE company, LLC, Houston, TX (US)

(21) Appl. No.: 16/985,015

(22) Filed: Aug. 4, 2020

Related U.S. Application Data
(62) Division of application No. 15/996,139, filed on Jun. 1, 2018.
(60) Provisional application No. 62/514,538, filed on Jun. 2, 2017.

(51) Int. Cl. B01D 53/52; C10G 29/22; C10L 3/10; B01D 53/14; C10G 29/06; C10G 29/24; C10G 29/04; C10G 29/20

(52) U.S. Cl. CPC B01D 53/52; C10G 29/22; C10L 3/102; B01D 53/1493; C10G 2300/202; C10G 29/24; C10G 29/04; C10G 29/20; C10G 29/06

(57) ABSTRACT

A method for scavenging hydrogen sulfides from hydrocarbon or aqueous streams and/or reducing or inhibiting solids or scale formation comprising introducing an additive made up of architectured materials such as star polymers, hyperbranched polymers, and dendrimers that may be used alone or in conjunction with aldehyde-based, triazine-based and/or metal-based hydrogen sulfide scavengers to an aqueous or hydrocarbon stream. A treated fluid comprising a fluid containing hydrogen sulfide and an additive for scavenging hydrogen sulfide or reducing or inhibiting solids and scale formation made up of architectured materials such as star polymers, hyperbranched polymers, and dendrimers. The fluid may further include aldehyde-based, triazine-based and/or metal-based hydrogen sulfide scavengers.

### CROSS-REFERENCE TO RELATED APPLICATION

This application is a divisional application of U.S. patent application Ser. No. 15/996,139 filed Jun. 1, 2018, which in turn claims the benefit of Provisional Patent Application No. 62/514,538 filed Jun. 2, 2017, both of which are incorporated by reference herein in their entireties.

### TECHNICAL FIELD

The present invention relates to additives for scavenging hydrogen sulfide. The present invention particularly relates to architectured material additives for scavenging hydrogen sulfide that are also useful for reducing or inhibiting solids and/or scale formation during treatment of hydrocarbon and aqueous streams related to oil and gas production and refining.

### BACKGROUND

The removal of hydrogen sulfide and other sulfur species from hydrocarbon fluids and aqueous streams in oil and gas production and refining is important because of the many safety and environmental hazards posed by the presence of such species.

For example, during combustion, sulfur-rich hydrocarbon streams produce heavy environmental pollution. When sulfur-rich streams contact metals, sulfur species lead to brittleness in carbon steels and to stress corrosion cracking in more highly alloyed metals used in oil and gas production and refining operations. Moreover, hydrogen sulfide in various hydrocarbon or aqueous streams poses an environmental hazard if the hydrogen sulfide in these streams is released into the air or water sources.

Triazine and glyoxal are two of the most widely used hydrogen sulfide scavengers. However, using these compounds often results in the formation of oligomeric and polymeric sulfur-containing structures that instigates deposit build-up in the system. Removal of these solids may be difficult and oftentimes results in lost operational time. For example, use of triazines can result in the formation of dithiazines, especially at colder conditions. Triazines react quickly in aqueous environments but disperse poorly in crude oil conditions, thus slowing down reaction kinetics. In crude oil conditions, triazine is spent at a very high level where amorphous dithiazine will most likely form.

Metals such as zinc (Zn) and Iron (Fe) are also known to effectively scavenge hydrogen sulfide in fluid streams found in oil and gas production and refining. Typically, zinc is being used as zinc carboxylate to help the metal dissolved in an organic environment and enable the Zn to make contact with dissolved hydrogen sulfide. Nowadays, the most common system being used is zinc octoate. However, zinc octoates tend to form highly viscous materials making their practical usefulness as a hydrogen sulfide scavenger limited.

Aqueous streams are also often treated to prevent the formation of scale in water systems. For instance, scale tends to accumulate on internal walls of various water systems, such as cooling water towers, and thereby materially lessens the operational efficiency of the system.

It would thus be desirable in the art to devise additives that could be introduced to hydrocarbon and aqueous stream for more effective scavenging of hydrogen sulfides and increased dispersion of precipitants in the stream for better reduction or inhibition of solids and scale formation.

### SUMMARY OF THE INVENTION

There is provided in one aspect, methods for scavenging hydrogen sulfide from fluid streams contaminated with hydrogen sulfide and for reducing or inhibiting solids and/or scale formation in aqueous or hydrocarbon streams comprising: introducing into a fluid stream that is contaminated with hydrogen sulfide an additive useful for scavenging hydrogen sulfide comprising an architectured material selected from the group consisting of star polymers, hyperbranched polymers, dendrimers and combinations thereof in an amount effective to reduce the amount of hydrogen sulfide, reduce the amount of scale formation, and/or reduce the amount of solids formation. The architectured materials may be used alone or in conjunction with aldehyde-based, triazine-based and/or metal-based hydrogen sulfide scavengers.

There is additionally provided a treated fluid comprising a fluid containing hydrogen sulfide and an additive for scavenging hydrogen sulfide and/or reducing or inhibiting solids and scale formation in the fluid, the additive being made up of architectured materials such as star polymers, hyperbranched polymers, dendrimers and combinations thereof in an amount effective to reduce the amount of hydrogen sulfide, reduce the amount of scale formation, and/or reduce the amount of solids formation. The fluid may further include aldehyde-based, triazine-based and/or metal-based hydrogen sulfide scavengers.

### DETAILED DESCRIPTION

It has been discovered that architectured materials such as star polymers, hyperbranched polymers, and dendrimers may be useful in more effectively scavenging of hydrogen sulfide contaminated streams with reduced or inhibited formation of solids or scale.

These differentially architectured materials have been shown to provide variable functionalities and structures that increase reaction kinetics with sulfur containing compounds and an increase loading of sulfur-containing compounds within the architecture. These architectured materials have more functional groups that may serve as a vehicle for small molecules tailored to react with the sulfur containing compounds. In addition, these architectured materials may aid in preventing polymerization and solids formation, and may aid in the dispersion of precipitated sulfides and thus keep the solids in suspension.

For these same reasons, it has also been discovered that such architectured materials may serve to reduce or inhibit the solid reaction products and other reaction precipitants resulting from the use of aldehyde-based, triazine-based and/or metal-based (e.g. zinc-based) hydrogen sulfide scavengers in hydrocarbon and aqueous streams. In addition to aiding in the dispersion of precipitated sulfides and thus keep the solids in suspension, the varied functionality of architectured materials such as star polymers, hyperbranched polymers, and dendrimers may be useful in reacting or forming complexes with the products of the reaction of the hydrogen sulfide in the stream and these scavengers.

In the case of the zinc-based hydrogen sulfide scavengers, for example, zinc scavenges sulfides by forming zinc sulfide and/or other zinc complexes with the sulfide. In some cases though, zinc sulfide tends to aggregate and form a scale and can deposit on surfaces. With the use of the hyperbranched polymers, zinc scale formation and deposition could be prevented or inhibited. One way of doing this may be by entrapping the zinc, zinc sulfide and/or other zinc complexes within the branches of the hyperbranched polymers. Also, zinc octoates tend to form highly viscous materials when used. The architectured materials disclosed herein may stabilize and enhance zinc solubility or the solubility of other divalent metals, such as Fe, Ni, Co, and/or Mg, that may be used in hydrogen sulfide scavengers. Such architectures may not only impart stability and good solubilization of in petroleum streams but may also facilitate the easy access of the hydrogen sulfide by the metal.

It has further been discovered that these architectured materials are effective in reducing or inhibiting scale formation in aqueous systems like cooling towers by inhibiting the aggregation of bigger scales. They also can serve to efficiently disperse small scale aggregates. The architectured polymers may be non-phosphorous.

The architectured materials useful for such purposes may be star polymers, hyperbranched polymers, and dendrimers. In non-limiting embodiments, these materials may be hyperbranched polymers, oligomers, dendrimers with acid, ester, amine, amide, alcohol functional groups. Suitable star polymers, hyperbranched polymers, and dendrimers include, but are not necessarily limited to, carbon, nitrogen, oxygen, phosphorus, sulfur, and combinations thereof.

These architectured materials may be used by themselves or in conjunction with other hydrogen scavengers, such as aldehyde-based, triazine-based and/or metal-based hydrogen sulfide scavengers. Suitable aldehyde-based scavengers include mono, di and poly aldehydes. Suitable triazine-based scavengers include alkyl, alcohol, carboxylic acid, amine and ester derivatives. Metal-based scavengers that may be used with the materials include zinc carboxylates like zinc octoate, zinc oxide, zinc chloride, zinc acetate, zinc ammonium carbonate, zinc sulfate, and other zinc salts like zinc salts containing hydrocarbyl group in combination with an oil soluble amine formaldehyde reaction product. Other metal based-scavengers can also include divalent metals like Fe, Ni, Co, Mg, and their combinations thereof.

The architectured materials described herein are useful in treating hydrocarbon or aqueous streams that occur in the production and refining of oil and gas, or mixtures and combinations of water and/or hydrocarbons.

The hydrocarbon streams may be crude, partially refined, or fully refined and pending commercial consumption. When the hydrocarbons to be treated are crude hydrocarbons, in one embodiment they may be very “crude” and be, for example, crude oil or heavy fuels oils or even asphalt. In another embodiment, the crude hydrocarbon may only be “crude” in regard to a subsequent refining step. Crude oil, when first produced is most often a multiphase fluid. It will have a hydrocarbon phase, aqueous phase, and may include both gases and solids. In some applications of the method of the disclosure, the additive may be employed in process water such as that produced during crude oil refining and even in wastewater that may be similarly contaminated. Hydrocarbon streams may also include production fluids and mixed production fluid streams.

Aqueous streams are any production or refining fluid streams containing water, brine, seawater. Exemplary aqueous stream include streams production fluids, completion fluids, and streams flowing through aqueous systems such as cooling towers, a cooling water systems, air-conditioning systems, wastewater treatment systems, deionized water systems, and combinations thereof.

The amount of the architectured materials that may be added to the fluid stream may range from about 20000 ppm to about 1 ppm. The concentration of the architectural materials in the additive may range from about 100% to about 1% of the additive.

Further it is expected that the methods and compositions herein will not be particularly limited by any temperature range, pressure range, pH range, or the like, and that the methods and compositions are expected to be useful in the normal operating ranges of the fluid streams treated as discussed herein.

The architectural material additive may inhibit, suppress, or reduce the amount of scale or solids formation. That is, it is not necessary for such formations to be entirely prevented for the methods or systems discussed herein to be considered effective, although complete prevention is a desirable goal. Success is obtained if less formation occurs using the additive than in the absence of the additive. Alternatively, the methods and systems described are considered successful if there is at least a 50% decrease in formation within stream or system. Similarly the architectural material additive may inhibit, suppress, or completely remove the H₂S that may be present. That is, it is not necessary for all of the hydrogen sulfide to be removed for the methods or systems discussed herein to be considered effective, although complete removal is a desirable goal. Further, it will be appreciated that by “removal” of H₂S is meant that the H₂S reacts with a hydrogen sulfide scavenger that gives a product that is less problematic that H₂S itself

In the foregoing specification, the invention has been described with reference to specific embodiments thereof. However, it will be evident that various modifications and changes can be made thereto without departing from the broader scope of the invention as set forth in the appended claims. Accordingly, the specification is to be regarded in an illustrative rather than a restrictive sense. For instance, other star polymers, hyperbranched polymers, dendrimers, fluid streams, hydrogen sulfide scavengers, besides those specifically mentioned or identified but which nevertheless fall within the appended claims can be suitable.

The present invention may suitably comprise, consist or consist essentially of the elements disclosed and may be practiced in the absence of an element not disclosed. For example, the methods may consist of or consist essentially of adding an architectured material selected from the group consisting of star polymers, hyperbranched polymers, dendrimers and combinations thereof in an amount effective to reduce the amount of hydrogen sulfide, reduce the amount of scale formation, and/or reduce the amount of solids formation to an aqueous stream or a hydrocarbon stream or combinations thereof.

There may be further provided a treated fluid comprising, consisting essentially of, or consisting of a fluid containing hydrogen sulfide and an additive for scavenging hydrogen sulfides or reducing solids and scale formation comprising an architectured material selected from the group consisting of star polymers, hyperbranched polymers, dendrimers and combinations thereof in an amount effective to reduce the amount of hydrogen sulfide, reduce the amount of scale formation, and/or reduce the amount of solids formation.

In another non-limiting embodiment, a treated fluid may comprise, consist essentially of, or consist of, a fluid and an architectured material selected from the group consisting of star polymers, hyperbranched polymers, and dendrimers.

As used herein, the terms “comprising,” “including,” “containing,” “characterized by,” and grammatical equivalents thereof are inclusive or open-ended terms that do not exclude additional, unrecited elements or method acts, but also include the more restrictive terms “consisting of” and “consisting essentially of” and grammatical equivalents thereof. As used herein, the term “may” with respect to a material, structure, feature or method act indicates that such is contemplated for use in implementation of an embodiment of the disclosure and such term is used in preference to the more restrictive term “is” so as to avoid any implication that other, compatible materials, structures, features and methods usable in combination therewith should or must be, excluded.

As used herein, the singular forms “a,” “an,” and “the” are intended to include the plural forms as well, unless the context clearly indicates otherwise.

As used herein, the term “and/or” includes any and all combinations of one or more of the associated listed items.

As used herein, the term “about” in reference to a given parameter is inclusive of the stated value and has the meaning dictated by the context (e.g., it includes the degree of error associated with measurement of the given parameter).

What is claimed is:

1. A method for treating fluid streams contaminated with hydrogen sulfide comprising:
introducing into a fluid stream that is contaminated with hydrogen sulfide an additive useful for scavenging hydrogen sulfide comprising an architectured material selected from the group consisting of star polymers, hyperbranched polymers, dendrimers, and combinations thereof in an amount effective to reduce the amount of hydrogen sulfide.

2. The method of claim 1 where the fluid stream is selected from the group consisting of a hydrocarbon stream, an aqueous stream, and combinations thereof.

3. The method of claim 1 where the additive further comprises at least one additional hydrogen sulfide scavenger selected from the group consisting of:
an aldehyde-based hydrogen sulfide scavenger;
a triazine-based hydrogen sulfide scavenger;
a metal-based hydrogen sulfide scavenger, where the metal is selected from the group consisting of Zn, Fe, Ni, Co, Mg, and combinations thereof; and
combinations thereof.

4. The method of claim 1 where the architectured material further comprises a metal selected from the group consisting of Zn, Fe, Ni, Co, Mg, and combinations thereof.

5. The method of claim 5 where the metal-based hydrogen sulfide scavenger is selected from the group consisting of zinc octoate, zinc oxide, zinc chloride, zinc acetate, zinc ammonium carbonate, zinc sulfate, zinc salts containing hydrocarbyl group in combination with an oil soluble amine formaldehyde reaction product, and combinations thereof.

6. The method of claim 1 where the effective amount of the additive comprises from about 20000 ppm to about 1 ppm of the architectured materials based on the fluid stream, and where the concentration of the architectural materials in the additive may range from about 100% to about 1% of the additive.

7. The method of claim 1 where the additive is introduced in an amount effective to also reduce solids and scale formation in the fluid stream as compared to a fluid stream absent the additive.

8. A method for treating fluid streams contaminated with hydrogen sulfide comprising:
introducing into a fluid stream that is contaminated with hydrogen sulfide an additive useful for scavenging hydrogen sulfide comprising an architectured material selected from the group consisting of star polymers, hyperbranched polymers, dendrimers, and combinations thereof in an amount ranging from about 20000 ppm to about 1 ppm of the architectured materials based on the fluid stream, and where the concentration of the architectural materials in the additive may range from about 100% to about 1% of the additive, which amount is effective to:
reduce the amount of hydrogen sulfide; and also
reduce solids and scale formation in the fluid stream as compared to a fluid stream absent the additive;
where the additive further comprises at least one additional hydrogen sulfide scavenger selected from the group consisting of:
an aldehyde-based hydrogen sulfide scavenger;
a triazine-based hydrogen sulfide scavenger;
a metal-based hydrogen sulfide scavenger, where the metal is selected from the group consisting of Zn, Fe, Ni, Co, Mg, and combinations thereof; and
combinations thereof;

9. The method of claim 8 where the fluid stream is selected from the group consisting of a hydrocarbon stream, an aqueous stream, and combinations thereof.

10. The method of claim 8 where the architectured material further comprises a metal selected from the group consisting of Zn, Fe, Ni, Co, Mg, and combinations thereof.

11. The method of claim 8 where the metal-based hydrogen sulfide scavenger is selected from the group consisting of zinc octoate, zinc oxide, zinc chloride, zinc acetate, zinc ammonium carbonate, zinc sulfate, zinc salts containing hydrocarbyl group in combination with an oil soluble amine formaldehyde reaction product, and combinations thereof.

12. The method of claim 8 where the solids are formed by the reaction of at least one additional hydrogen sulfide scavenger with hydrogen sulfide.

13. The method of claim 12 further comprising the architecture material suspending the solids in the fluid stream.
